(19) United States
(12) Patent Application Publication
(10) Pub. No.: US 2007/0059999 A1
(43) Pub. Date: Mar. 15, 2007

(54) Stretchy polyolefin woven wrap

(76) Inventor: Trevor Arthurs, Truro (CA)

Correspondence Address: ROBERTS, MARDULA & WERTHEIM, LLC, 11800 SUNRISE VALLEY DRIVE, SUITE 1000, RESTON, VA, 20191, US

(21) Appl. No.: 11/518,772

(22) Filed: Sep. 11, 2006

Related U.S. Application Data
(60) Provisional application No. 60/715,795, filed on Sep. 9, 2005.

(51) Int. Cl. B32B 27/12

(52) U.S. Cl. 442/43; 442/2; 442/49

(57) ABSTRACT

A stretchy polyolefin wrap has an inner woven scrim that is extrusion coated on one or both sides. The reinforcing polyolefin tapes of the inner woven scrim of the polyolefin wrap are made at a draw ratio of about 2:1 to about 4:1. The lower draw ratio of the stretchy polyolefin tape helps to achieve a modulus and orientation suitable for use in the automated wrapping process of lumber. The stretchy polyolefin wrap can be stretched over a stack of lumber at relatively low stress levels and maintained around the stack of lumber in the stretched state without becoming loose and without the use of staples.

### CROSS REFERENCE TO RELATED APPLICATIONS

This application claims priority benefit under 35 U.S.C. § 119(e) from provisional application No. 60/715,795, filed Sep. 9, 2005. The 60/715,795 application is incorporated by reference herein, in its entirety, for all purposes.

### FIELD OF THE INVENTION

The present invention relates to a protective covering for lumber. More particularly, it relates to a stretchy polyolefin wrap which can be used by an automated wrapping unit to cover lumber.

### BACKGROUND INFORMATION

It has been a practice in the lumber industry to manually wrap stacks of lumber in a coated polyolefin woven fabric to protect the lumber from exposure to the elements during shipping and storage. When such covering is provided in roll form to the lumber mills, it is first unrolled, then folded over the lumber and stapled into place. Alternatively, the fabric covering may be provided as separate pre-formed covers that are configured in the shape and size of the stack of lumber. Use of such pre-formed covers for wrapping lumber requires less labor at the lumber mill but the pre-formed covers are more expensive to produce because they must be sewn.

Regardless of which procedure is utilized to wrap the lumber, it has typically been the practice to secure the covering to the lumber using staples. The use of staples to secure the covering to a stack of lumber has many disadvantages. Staples can severely damage the lumber into which they are inserted. Staples tend to stay embedded in the lumber when the cover is pulled off at a retail lumber yard, and then must be removed manually. The stapling procedure is time consuming and therefore expensive.

Recently, automated wrapping equipment has been introduced to a few lumber mills. Automated wrapping, compared to manual wrapping procedures, offers significant savings in time and production costs. Automated wrapping offers the additional advantage of eliminating the need for stapling the cover to the lumber. The AUTOWRAPTOR, by J. Desco Inc., is one example of such an automatic wrapping unit. The automatic wrapping unit utilizes rolls of plastic film to prepare covers for wrapping stacks of lumber. The film cover is configured with dimensions slightly smaller than the stack of lumber. The wrapping unit automatically cuts, seals and stretches the film cover around the edges. The wrapping unit places the cover over the stack of lumber by stretching the cover to increase its dimensions and lowering the cover over the stack of lumber. The wrapping unit then releases the cover and the cover is held in place around the stack of lumber by the force of the stretched film. As a result, the cover in this released position holds itself in place around the stack of lumber without the use of staples.

he low tear propagation strength of non-reinforced films has been has been one factor that limits use of the plastic film in the automated wrapping process. Additionally, once stretched, the film tends to relax (i.e., lose elasticity) over time. This relaxation of the film leads to a very loose package that is prone to damage or being blown off during transport.

The conventional polyolefin fabrics that have been used traditionally to wrap lumber (as in the non-automated wrap processes described above) are more durable than the film covers used in the automated wrapping process. However, conventional polyolefin fabrics have very little stretch. Thus, conventional polyolefin fabrics have not been suitable for use in the automated wrapping process.

What is needed is a polyolefin fabric which can withstand stretching as well as provide durability for use in the automated lumber wrapping process.

### SUMMARY OF THE INVENTION

The present invention may be embodied as a stretchy polyolefin wrap that has an inner woven fabric, which is extrusion coated on one or both sides. The tapes used to produce the inner woven fabric of the polyolefin wrap are made at a draw ratio of about 2:1 to about 4:1. The lower draw ratio of the polyolefin tape helps to achieve a woven fabric with a modulus and orientation suitable for use in the automated wrapping machines. The stretchy polyolefin wrap can be stretched over a stack of lumber at relatively low stress levels and maintained around the stack of lumber in the stretched state without becoming loose and without the need to use staples.

The present invention may also be embodied as a process for manufacturing such stretchy polyolefin wrap. A polyolefin woven fabric is woven from polyolefin tape that has been made stretchy via a draw ratio of about 2:1 to about 4:1, and is then coated on at least one site with a polyolefin coating.

One aspect of this invention is that it provides a fabric covering for lumber that can withstand stretching during the automated wrapping process.

Another aspect of this invention is that it provides a fabric covering for lumber which provides adequate protection from the elements during shipping and storage.

According to a first embodiment of the invention, a stretchy polyolefin wrap has a woven scrim layer and a polymer coating layer. The woven scrim is formed from polyolefin reinforcing tapes made at a draw ratio in the range of about 2:1 to about 4:1. The polymer coating layer disposed on at least one surface of the woven scrim.

According to a second embodiment of the invention, a stretchy polyolefin wrap has a woven scrim layer and a polyolefin coating layer. The woven scrim is formed from polyolefin reinforcing tapes made at a draw ratio in the range of about 2:1 to about 4:1. The polyolefin coating layer is disposed on both surfaces of the woven polyolefin scrim.

According to a second embodiment of the invention, a method of making stretchy polyolefin wrap includes steps of forming polyolefin tape, weaving the polyolefin tape to form a woven scrim, and coating the woven scrim. Forming the polyolefin tape is via extrusion with a draw ratio in the range of about 2:1 to about 4:1. The polyolefin tape is then woven to form a woven scrim. The woven scrim is coated on at least one side with a polyolefin coating layer.

### BRIEF DESCRIPTION OF THE DRAWINGS

FIG. 1 illustrates a sectional view of a stretchy polyolefin wrap according to the present invention that has a polyolefin woven fabric with coating layers on each side.

FIG. 2 illustrates a flowchart of process steps, according to one aspect of the present invention, for making of a stretchy polyolefin wrap.

FIG. 3 illustrates a conceptual view an exemplary embodiment where a polyolefin woven fabric is extrusion coated with coating layers on each side.

### DETAILED DESCRIPTION

One embodiment of the present invention is directed to a stretchy polyolefin wrap for wrapping stacks of lumber or other products.

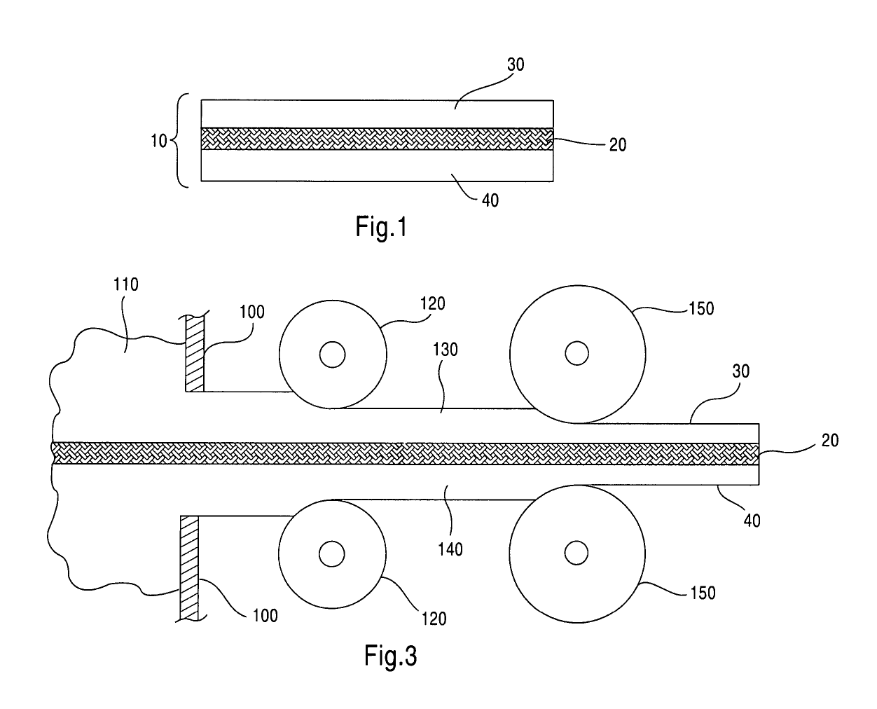

Referring to FIG. 1, the stretchy polyolefin wrap 10 of this embodiment has an inner woven scrim 20 and one or more coating layers 30, 40. The woven scrim 20 is shown as having both an upper coating layer 30 and lower coating layer 40. Preferably, the woven scrim 20 is formed from oriented flat polyolefin tapes woven into fabric although this is not meant as a limitation. Techniques and methods of producing woven fabrics are well known in the art.

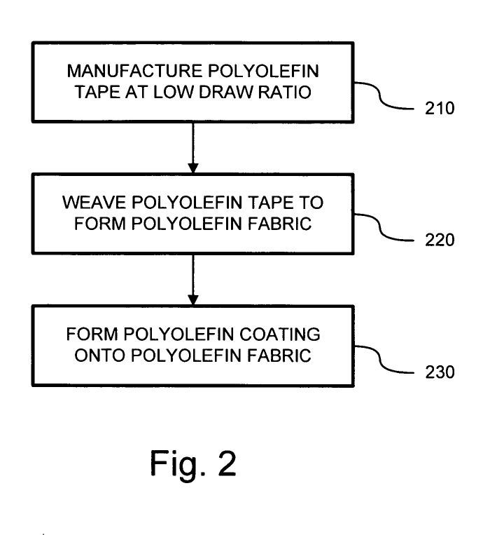

Referring to FIG. 2, the oriented tape used to weave (FIG. 3, 220) the inner woven scrim 20 of the polyolefin wrap 10 is made (FIG. 3, 210) at a lower draw ratio than what is typical for conventional polyolefin fabrics. Preferably, the inner woven fabric 20 is made at a draw ratio of about 2:1 to about 4:1. Surprisingly, it has been found that the lower draw ratio for the polyolefin tape renders the woven scrim 20 stretchy so as to be particularly suitable for use by automated wrapping machines for wrapping lumber or other bulk products. The lower draw ratio of the stretchy polyolefin tape helps to achieve a modulus and orientation sufficient to allow the wrap 10 to be stretched over a stack of lumber at relatively low stress levels and maintained around the stack of lumber in the stretched state without creeping or becoming loose. Furthermore, the tear propagation resistance of the stretchy polyolefin wrap 10 is much higher than the film covers that have typically been used in the automatic wrapping machines.

According to preferred embodiments, the inner woven scrim 20 is selected from polypropylene woven fabrics and high density polyethylene woven fabrics. Such fabrics are known for good strength, high flexibility, low cost and ease of manufacture. Further, numerous commercial sources exist for such fabrics.

The inner woven scrim 20 may have a denier value ranging from 200 to 2000. In a preferred embodiment, the denier value is 972. The count may range from about 2 to about 12 tapes per inch. According to one embodiment, the count ranges from 4 to 12 in the warp direction and from 2 to 8 in the weft direction.

The coating layers 30, 40 may be applied (FIG. 2, 230) to one or both sides of the scrim 20. Coating thicknesses will vary from 0.5 to 4 mils. Such coatings may be applied to the inner woven scrim layer 20 by using such techniques as extrusion coating (i.e., extruding one layer onto the other) or lamination (i.e., bonding layers together under heat and pressure).

Referring to FIG. 3, the coating of a polyolefin woven fabric is illustrated. Coatings 30, 40 are extruded onto the inner polyolefin woven fabric 20. As an example, extrusion coating of woven scrim 20 is accomplished by melting the coating in an extruder and extruding through a film die 100 onto the woven fabric 20. The molten polymer 110 and fabric 20 are transported together between a nip roll 120 and a large chill roll 150 to cool the molten coatings 130, 140 into cooled polymer layers 30, 40.

Although not strictly required to practice the present invention, it is preferable to use polyolefins for the coating layers 30, 40. Suitable polyolefins include, but are not limited to, low density polyethylene (LDPE), linear low density polyethylene (LLDPE), polypropylene (PP), ethylene-methyl acrylate (EMA), and ethylene vinyl acetate (EVA). It is important that the polyolefin coatings selected be compatible with the woven fabric to which they are applied.

The coatings may optionally incorporate additives in amounts up to 30% by weight and include (without limitation) antioxidants, UV stabilizers, flame retardant agents, slip agents, antiblock additives, printable additives, paper match additives, polar additives, colorants, and pigments. Hindered phenols (e.g., Irganox® 1010) are useful antioxidant additives that may be incorporated in the coatings, as are phosphites (e.g., Irgafos® 168). Examples of suitable UV stabilizers are Tinuvin® 328, Chimassorb® 944, and UV100. The additives Irganox® 1010, Irgafos® 168, Tinuvin® 328, and Chimassorb® 944 are all registered trademarks of, and supplied by Ciba-Geigy Corporation, of New York. The UV100 additive is a product of Ampacet Corporation and is based on Ciba Specialty Chemical's proprietary Shelfplus®. Useful flame retardant agents are readily commercially available from A. Schulman of Akron, Ohio, Clariant of Easton, Md., and Technical Polymer Representatives of Amherst, Ohio. Examples of suitable slip agents are erucamide and stearamide (either separately or in combination). Suitable paper match additives are readily commercially available from A. Schulman of Akron, Ohio.

Inclusion of such additives is useful to the extent that the additives do not interfere with the adhesive and soft tactile properties of the coatings. When used, pigments and colorants are preferably added as part of a color masterbatch. The color masterbatch is formed by combining the pigments (colorant) with a polypropylene and/or polyethylene carrier compatible with the polyolefin coatings. In general, compatible carriers can be determined by creating extruded melt blends and testing for phase separation in the extrudate.

### EXAMPLE

The following working example of practice of the invention is illustrative and is not meant to limit the scope of the invention.

A woven polyolefin fabric according to the present invention was manufactured at a draw ratio of 3:1 for use by an automatic wrapper to cover stacks of lumber. A high density polyethylene warp tape was used and coatings were applied on both sides in an extrusion coating process. Properties of the tape of the present invention compared to a standard HDPE warp tape are set forth in Table 1.

TABLE 1

| | | Standard HDPE |
|---|---|---|
| | Example Tape | Warp Tape |
| Denier (g/9000) | 972 | 950 |
| Draw Ratio | 3:1 | 4:1 |
| Elongation to Failure (%) | 59 | 23 |
| Tenacity (g/denier) | 3.6 | 4.5 |
| Shrinkage (%) at 212° F. | 0.5 | 3 |

A stretchy polyolefin woven wrap and method of making same have been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. For example, the thermoplastic vulcanizate may be selected to provide the desired pigment or to include desired additives such as UV stabilizer or flame retardant. Further, any reference to claim elements in the singular, for example, using the articles “a,” “an,” or “the” is not to be construed as limiting the element to the singular.

What is claimed is:

1. A stretchy polyolefin wrap comprising:
a woven scrim comprising polyolefin reinforcing tapes made at a draw ratio in the range of about 2:1 to about 4:1; and
a polymer coating layer disposed on at least one surface of the woven scrim.

2. The stretchy polyolefin wrap of claim 1, wherein the woven scrim has a count in the range of from about 4 to about 12 tapes per inch in both the warp direction and from about 2 to about 8 tapes per inch in the weft direction.

3. The stretchy polyolefin wrap of claim 1, wherein the woven scrim has a denier value in the range of from about 200 to about 2000.

4. The stretchy polyolefin wrap of claim 1, wherein the polymer coating layer has a thicknesses of from about 0.5 mils to about 4 mils.

5. The stretchy polyolefin wrap of claim 1, wherein the polymer coating layer is applied to the woven scrim via extrusion coating.

6. The stretchy polyolefin wrap of claim 1, wherein the polymer coating layer is applied to the woven scrim via lamination.

7. The stretchy polyolefin wrap of claim 1, wherein the polymer coating layer comprises a polyolefin selected from the group consisting of: low density polyethylene, linear low density polyethylene, polypropylene, ethylene-methyl acrylate, and ethylene vinyl acetate.

8. The stretchy polyolefin wrap of claim 1, wherein the woven scrim comprises polypropylene woven fabric.

9. The stretchy polyolefin wrap of claim 1, wherein the woven scrim comprises high density polyethylene woven fabric.

10. A stretchy polyolefin wrap comprising:
a woven scrim comprising polyolefin reinforcing tapes made at a draw ratio of about 3:1; and
polyolefin coating layers disposed on the surfaces of the woven scrim.

11. The stretchy polyolefin wrap of claim 10, wherein the woven scrim has a count in the range of from about 4 to about 12 tapes per inch in both the warp and weft directions.

12. The stretchy polyolefin wrap of claim 10, wherein the woven scrim has a denier value in the range of from about 200 to about 2000.

13. The stretchy polyolefin wrap of claim 10, wherein the polyolefin coating layer has a thicknesses of from about 0.5 mils to about 4 mils.

14. The stretchy polyolefin wrap of claim 10, wherein the polyolefin coating layer is applied to the woven scrim via extrusion coating.

15. The stretchy polyolefin wrap of claim 10, wherein the polyolefin coating layer is applied to the woven scrim via lamination.

16. The stretchy polyolefin wrap of claim 10, wherein the polyolefin coating layer is selected from the group consisting of: low density polyethylene, linear low density polyethylene, polypropylene, ethylene-methyl acrylate, and ethylene vinyl acetate.

17. The stretchy polyolefin wrap of claim 10, wherein the woven scrim comprises polypropylene woven fabric.

18. The stretchy polyolefin wrap of claim 10, wherein the woven scrim comprises high density polyethylene woven fabric.

19. A method of making a stretchy polyolefin wrap, the method comprising:
forming polyolefin tape via extrusion with a draw ratio in the range of about 2:1 to about 4:1;
weaving the polyolefin tape into a woven scrim; and
coating the woven scrim on at least one side with a polyolefin coating layer.

20. The method of making a stretchy polyolefin wrap of claim 19, wherein the woven scrim is woven to have a count in the range of from about 4 to about 12 tapes per inch in both the warp and weft directions.

21. The method of making a stretchy polyolefin wrap of claim 19, wherein the woven scrim is woven to have a denier value in the range of from about 200 to about 2000.

22. The method of making a stretchy polyolefin wrap of claim 19, wherein the polyolefin coating layer is coated to a thicknesses of from about 0.5 mils to about 4 mils.

23. The method of making a stretchy polyolefin wrap of claim 19, wherein coating the woven scrim comprises extrusion coating.

24. The method of making a stretchy polyolefin wrap of claim 19, wherein coating the woven scrim comprises lamination.

25. The method of making a stretchy polyolefin wrap of claim 19, wherein the polyolefin tape comprises polypropylene.

26. The method of making a stretchy polyolefin wrap of claim 19, wherein the polyolefin tape comprises high density polyethylene.
